(19) United States
(12) Patent Application Publication
(10) Pub. No.: US 2024/0069420 A1
(43) Pub. Date: Feb. 29, 2024

(54) PROJECTOR CASE

(71) Applicant: CASIO COMPUTER CO., LTD., Tokyo (JP)

(72) Inventor: Kohei MIURA, Tokyo (JP)

(21) Appl. No.: 18/238,943

(22) Filed: Aug. 28, 2023

(30) Foreign Application Priority Data
Aug. 29, 2022 (JP) 2022-135500

(51) Int. Cl. G03B 21/16

(52) U.S. Cl. CPC G03B 21/16

(57) ABSTRACT

A projector case capable of accommodating a projector includes a case having formed therein an intake/exhaust port and multiple attachment target holes, the multiple attachment target holes being provided on an outer circumference of the intake/exhaust port, and a duct cover configured to be attached to the case in multiple orientations and having formed therein a connection opening connecting to the intake/exhaust port, an external opening communicating with the connection opening, and multiple attachment holes, the multiple attachment holes being provided on an outer circumference of the connection opening.

### CROSS-REFERENCE TO RELATED APPLICATION

This patent application is based upon and claims the benefit of priority under 35 USC 119 of Japanese Patent Application No. 2022-135500 filed on Aug. 29, 2022, the entire disclosure of which, including the specification, claims, drawings and abstract, is incorporated herein by reference in its entirety.

### BACKGROUND

### Technical Field

The present disclosure relates to a projector case.

### Description of the Related Art

There have conventionally been provided projector cases for use in setting a projector outside. For example, Japanese Unexamined Patent Application Publication No. 2021-173856 (JP-A-2021-173856) discloses a projector case in which an entrance suppression cover for suppressing an entrance of fluid such as rainwater into an outlet port or an inlet port is provided on an outlet port and an inlet port. A projector is mounted vertically via an attachment stay inside the projector case. The projector case is supported by a panning direction rotation element.

### SUMMARY

According to an aspect of the present disclosure, there is provided a projector case capable of accommodating a projector which includes a case having formed therein an intake/exhaust port and multiple attachment target holes, the multiple attachment target holes being provided on an outer circumference of the intake/exhaust port, and a duct cover configured to be attached to the case in multiple orientations and having formed therein a connection opening connecting to the intake/exhaust port, an external opening communicating with the connection opening, and multiple attachment holes, the multiple attachment holes being provided on an outer circumference of the connection opening.

### BRIEF DESCRIPTION OF THE DRAWINGS

FIG. 1 is a perspective view showing a projector case according to an embodiment of the present disclosure as viewed from a front thereof,

FIG. 2 is a perspective view showing the projector case according to the embodiment of the present disclosure as viewed from a rear thereof,

FIG. 3 is a bottom view of the projector case according to the embodiment of the present disclosure,

FIG. 4 is a plan view of the projector case according to the embodiment of the present disclosure with a case lid opened,

FIG. 5 is an exploded perspective view of the projector case according to the embodiment of the present disclosure, a projector, an AC adapter, which are disassembled,

FIG. 6 is a sectional view of the projector case according to the embodiment of the present disclosure taken along a line VI-VI in FIG. 3, accompanied by circled perspective views of a connector as viewed from a side A and a side B, respectively,

FIG. 7 is an exploded perspective view showing the projector case according to the embodiment of the present disclosure and a duct cover thereof separated from a case main body, accompanied by a circled view of the duct cover as seen from a side C,

FIG. 8 is a sectional view of the projector case according to the embodiment of the present disclosure taken along a line VIII-VIII in FIG. 3,

FIG. 9 is a perspective view of an internal duct of the projector case according to the embodiment of the present disclosure as viewed from an inside of the case main body,

FIG. 10 is a perspective view showing a case in which the projector case according to the embodiment of the present disclosure is suspended from a ceiling,

FIG. 11 is a perspective view showing a case in which the projector case according to the embodiment of the present disclosure is set for a floor projection,

FIG. 12 is a perspective view showing a case in which the projector case according to the embodiment of the present disclosure is set for a ceiling projection,

FIG. 13 is a perspective view showing a case in which the projector case according to the embodiment of the present disclosure is set for a vertical screen projection in a horizontal direction, and

FIG. 14 is a schematic diagram showing a modified example of an attachment target hole and an attachment hole in the projector case according to the embodiment of the present disclosure.

### DESCRIPTION OF THE EMBODIMENT

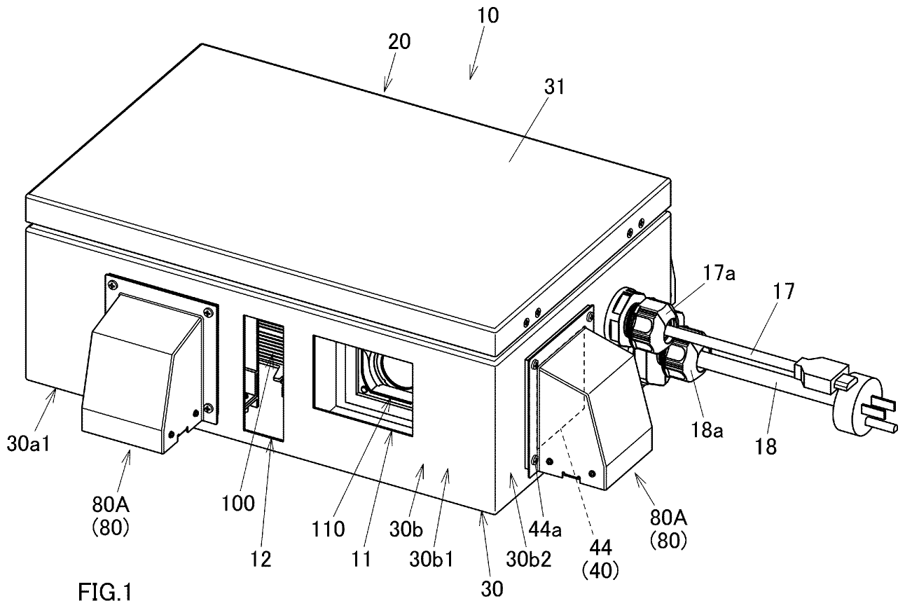

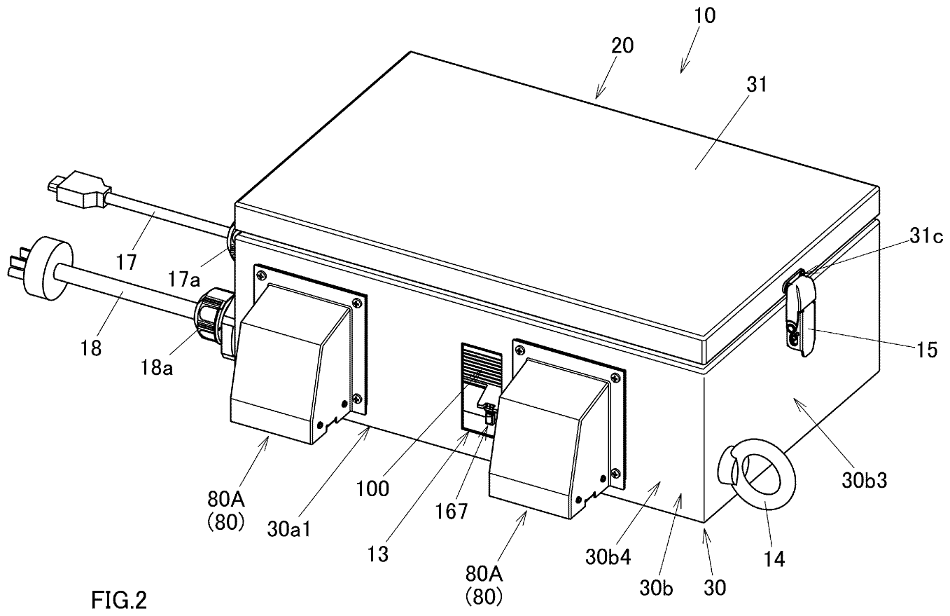

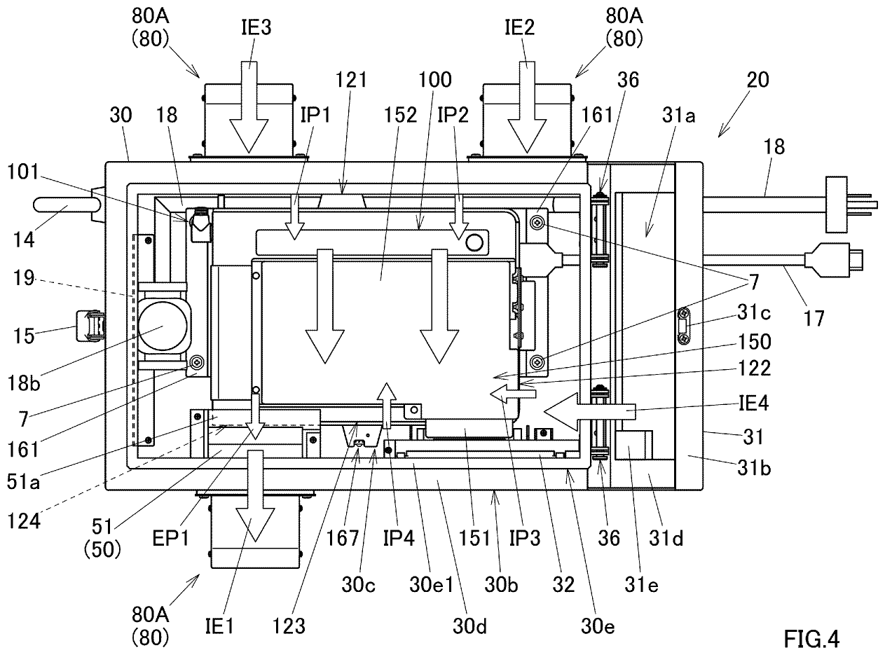

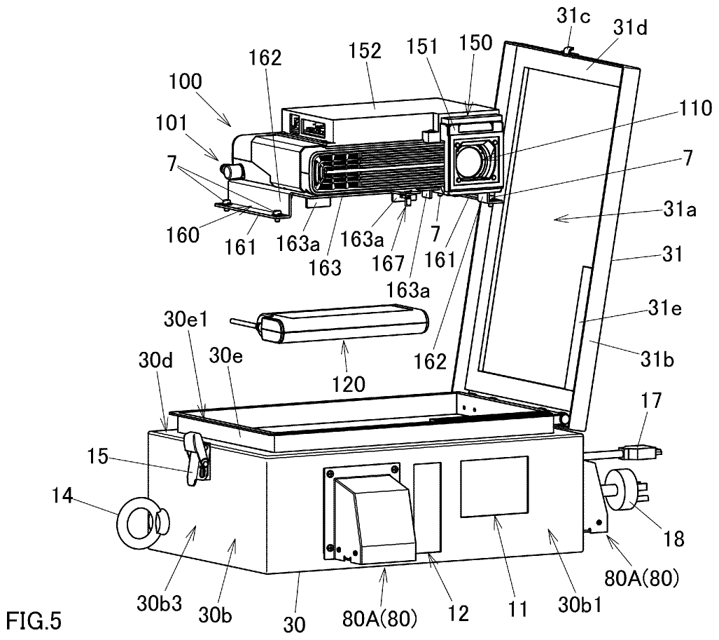

Hereinafter, an embodiment of the present disclosure will be described based on drawings. FIGS. 1 and 2 show a projector case 10 which is in such a state that the projector case 10 is placed flat so as to be set for a horizontal projection. A projector 100 is accommodated in the projector case 10 (also, refer to FIGS. 4 and 5). The projector case 10 includes substantially a rectangular parallelepiped case 20, and multiple duct covers 80 which are fixed to the case 20. The case 20 includes a case main body 30, and a case lid 31.

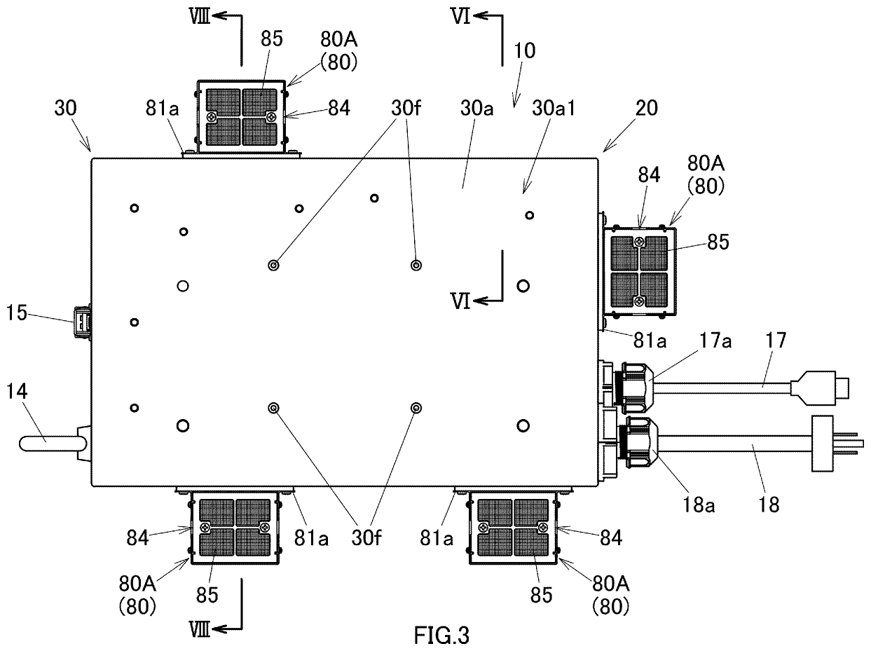

The case main body 30 has substantially a rectangular bottom plate 30a (refer to FIG. 3), and side plates 30b which are provided in such a manner as to be erected individually from front, rear, left, and right edges of the bottom plate 30a. An opposite side of the case main body 30 to the bottom plate 30a constitutes an opening area 30c (refer to FIG. 4). A projected light emitting port 11 for emitting projected light is provided in the side plate 30b of the case main body 30 in such a manner as to correspond to a projection port 110 of the projector 100.

Here, in the following description, when “up” and “down” are referred to in relation to the projector cover 10 (the projector 100), the side of the case main body 30 of the projector case 10 where the opening area 30c is provided (an upper side of the projector 100) denotes up or an upward direction, and the side of the case main body 30 of the projector cover 10 where the bottom plate 30a is provided (a lower side of the projector 100) denotes down or a downward direction. When “left” and “right” are referred to in relation to the projector case 10 (the projector 100), a left side when facing a projection direction from the projected light emitting port 11 (the projection port 110) denotes left or a leftward direction, and a right side when facing the projection direction denotes right or a rightward direction. When “front” and “rear” are referred in relation to the projector case 10 (the projector 100), a front relative to a traveling direction of projected light denotes a forward direction, and a rear relative to the traveling direction of the projected light denotes a rearward direction.

As shown in FIGS. 1 and 2, the side plates 30b of the case main body 30 include a front side plate 30b1, a left side plate 30b2, a right side plate 30b3, and a rear side plate 30b4. As shown in FIGS. 4 and 5, upper ends of the side plates 30b are bent through 90 degrees towards the opening area 30c so as to provide a frame surface 30d of substantially a rectangular frame shape in a plan view. Then, the case main body 30 includes an opening frame 30e of substantially a rectangular shape in a plan view, which is provided in such a manner as to be erected perpendicularly from the frame surface 30d. Here, the opening area 30c is defined by the opening frame 30e. An upper end of the opening frame 30e is bent through 90 degrees towards an outside, so that a frame-shaped surface 30e1 of substantially a rectangular frame shape in a plan view is provided.

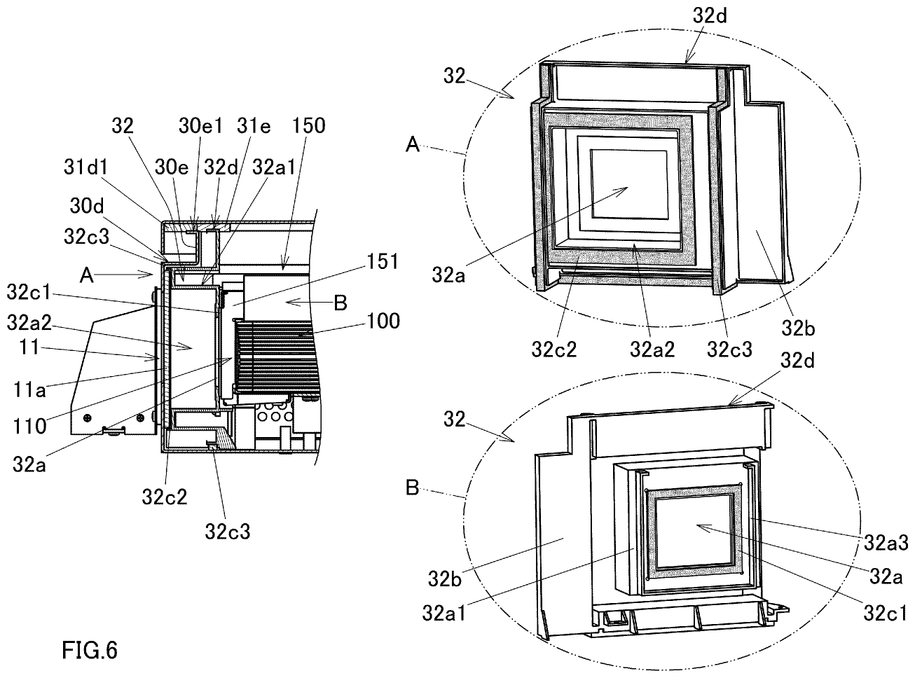

As shown in FIG. 6, a glass plate 11a is fixed to the projected light emitting port 11 provided in the front side plate 30b1 of the case main body 30 from an inside of the front side plate 30b1 by, for example, applying an adhesive around an edge portion thereof. A connector 32 of a frame-shaped block-like element is provided on a rear side of the glass plate 11a (also, refer to FIG. 4). The connector 32 connects with the projection port 110 of the projector 100.

As shown in circled diagrams in FIG. 6, the connector 32 includes a connecting element 32a1 of substantially a box shape which projects rearwards from a rear surface of a base plate 32b of substantially a rectangular plate shape. The connecting element 32a1 protrudes rearwards in a convex shape on the rear surface of the base plate 32b, and a front surface side of the base plate 32b which corresponds to the connecting element 32a1 has a concave shape, so that a space 32a2 is provided in a front side of the connecting element 32a1. A rectangular opening 32a is provided in the connecting element 32a1 in such a manner as to face the projection port 110 of the projector 100.

In the present embodiment, as shown in FIGS. 5 and 6, the projector 100 includes a zooming and focusing or ZF adjustment device 150 configured to adjust zooming and focusing by means of a remote control. Then, a zooming and focusing or ZF fixing device 151 of substantially a frame shape is attached to a circumference of the projection port 110 in such a manner as to expose the projection port 110 so that the ZF adjustment device 150 is attached to the projector 100. The ZF fixing device 151 faces the projection port 110 through an opening of substantially a frame shape formed in the ZF fixing device 151. Then, a front surface of the ZF fixing device 151 connects with a rear surface of the connecting element 32a1 of the connector 32. Here, in a sectional view in FIG. 6, only the projector case 10 is shown in section, and the projector 100 (the ZF adjustment device 150) is shown in a side view.

As shown in FIG. 6 and the circled diagram B in FIG. 6, a wall 32a3 of substantially a rectangular annular shape is provided on the rear surface of the connector 32 in such a manner that an upper side is opened, so that the ZF fixing device 151 is guided when the ZF fixing device 151 is attached. The rear surface of the connecting element 32a1 of the connector 32 and the front surface of the ZF fixing device 151 are connected together in such a manner that the projection port 110 is faced from the opening 32a. The rear surface of the connecting element 32a1 connects with the front surface of the ZF fixing device 151 via a cushion 32c1 of substantially a rectangular frame shape which is shown shaded. The cushion 32c1 is compressed by the connecting element 32a1 and the ZF fixing device 151. Similarly, as shown in the circled diagram A in FIG. 6, a front surface of the base plate 32b which surrounds the space 32a2 in the connector 32 connects with the rear surface of the glass plate 11a via a cushion 32c2 of substantially a rectangular frame shape which is shown shaded. The cushion 32c2 is compressed by the front surface of the base plate 32b which surrounds the space 32a2 and the rear surface of the glass plate 11a.

As a result, dust attempting to enter the space 32a2 from a portion where the projected light emitting port 11 and the glass plate 11a are connected together is reduced by the cushion 32c2. Further, dust and rainwater attempting to enter the space 32a2 from the inside of the projector case 10 is reduced by the cushion 32c1. That is, cushions 32c1, 32c2 constitute a dust-proof component which is provided between the projected light emitting port 11 and the projection port 110, and the connector 32. As a result, the entrance of dust and rainwater from the inside of the projector case 10 into the projection port 110 can be reduced by the connecting element 32a1.

Additionally, as shown in FIG. 6 and the circled diagram A in FIG. 6, cushions 32c3, which are shown shaded, are provided between locations of the case main body 30 (the front side plate 30b1, the bottom plate 30a, the frame surface 30d, the opening frame 30e) which correspond to the connector 32 and the connector 32 in such a manner as to be compressed thereby. The cushions 32c3 include two cushions which are provided on left and right sides of a front surface of the base plate 32b in such a manner as to extend in an up-down direction along the front surface while being connected to each other by an element which extends in a left-right direction between lower portions of the two cushions 32c3. To describe this specifically, in each of the two cushions 32c3 extending in the up-down direction, locations corresponding to the front side plate 30b1, the frame surface 30d, and the opening frame 30e are bent into a crank shape, and a location corresponding to the bottom plate 32a is provided in such a manner as to connect to the cushion 32c3 while extending rearwards.

The entrance of dust and rainwater into the projection port 110 from the inside of the projector case 10 can be reduced more by the cushions 32c3 which are configured as a dust-proof component. Here, a press contact between an upper end face 32d of the base plate 32b and a cushion 31e of the case lid 31, which will be described later, contributes to reducing dust and rainwater which attempt to enter from an outer circumference of the glass plate 11a. In addition, the connector 32 described heretofore can also be applied to an embodiment in which the ZF adjustment device 150 and the ZF fixing device 151 are not provided on the projector 100. In this case, as with the embodiment that has been described heretofore, dust and rainwater which attempt to enter the projection port 110 can be reduced by connecting the rear surface of the connecting element 32a1 to the front surface of the projector 100 (more specifically, a circumference of the projection port 110 in the front surface of the projector 100) via the cushion 32c1. In this case, the connector 32 does not have the wall 32a3.

Additionally, as shown in FIG. 1, an infrared ray transmission area 12 is provided to be opened in the front side plate 30b1 in a position lying to the right of the projected light emitting port 11, and this infrared ray transmission area 12 includes a transparent acrylic plate or the like which transmits an infrared ray with which the projector 100 is controlled remotely. A dust-proof treatment and a treatment for restricting the entrance of rainwater are also applied between the infrared ray transmission area 12 and the acrylic plate or the like which is provided on the infrared ray transmission area 12 as required.

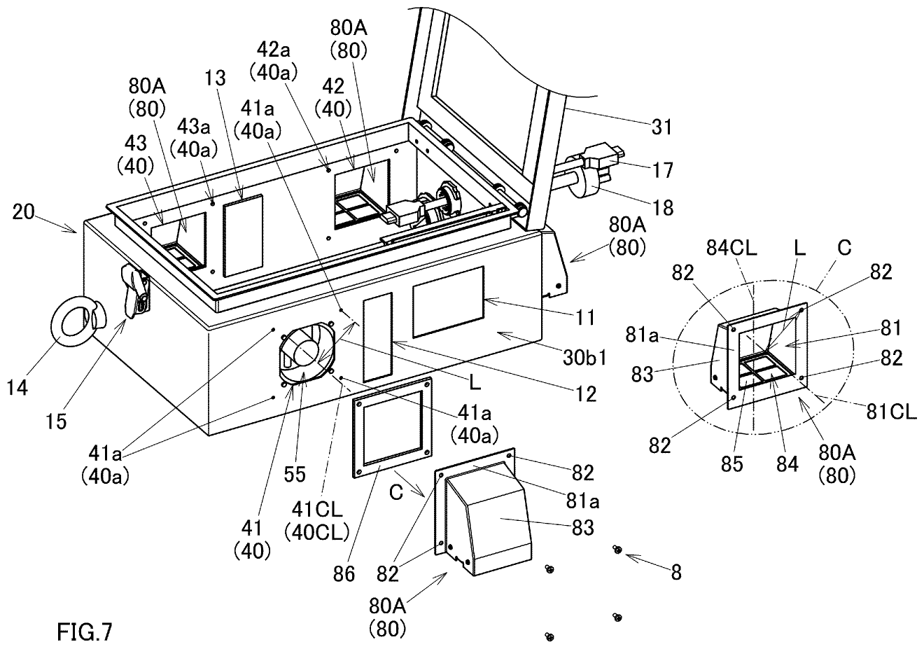

As shown in FIG. 7, a front intake/exhaust port 41 is provided on a right side of the infrared ray transmission area 12 in the front side plate 30b1 as an intake/exhaust port 40. Here, the intake/exhaust port 40 is configured as an opening port which penetrates the case main body 30 in such a manner as to provide a communication between an inside and an outside of the case 20 (the case main body 30). The front intake/exhaust port 41 is formed into substantially an octagonal shape. Multiple or four attachment target holes 41a are provided on an outer circumference of the front intake/exhaust port 41 as multiple attachment target holes 40a of the intake/exhaust port 40. The four attachment target holes 41a are arranged in such a manner as to be positioned individually at vertexes of a regular quadrangle. In other words, the four attachment target holes 41a are provided individually in positions lying a predetermined disposition dimension L from an axial center 41CL of the front intake/exhaust port 41 (an axial center 41CL which is at right angles to an opening plane in which the front intake/exhaust port 41 is opened). Then, an internal thread is provided in the attachment target holes 41a. Specifically speaking, a nut (not shown) is fixed to a position on the rear surface of the front side plate 30b1 which corresponds to each of the attachment target holes 41a.

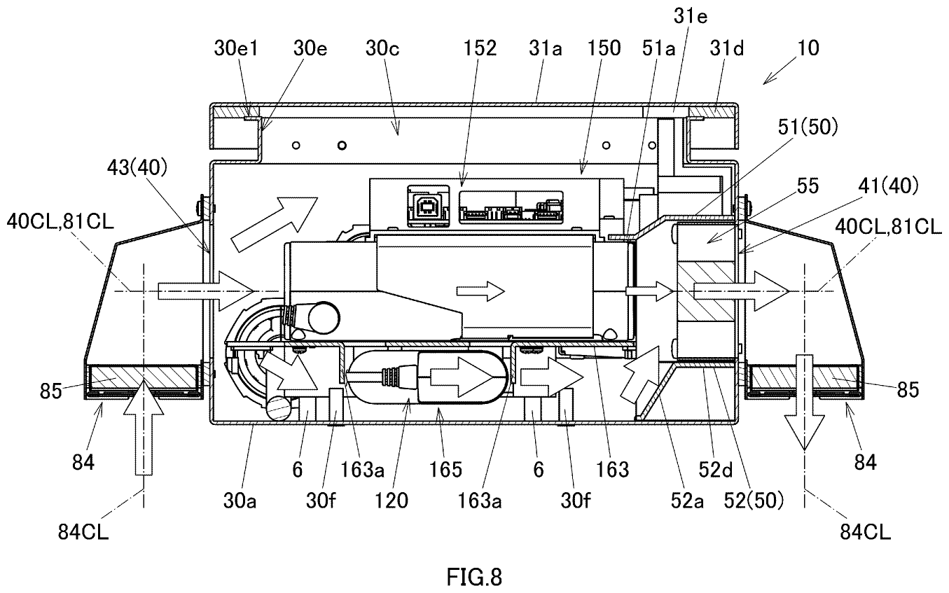

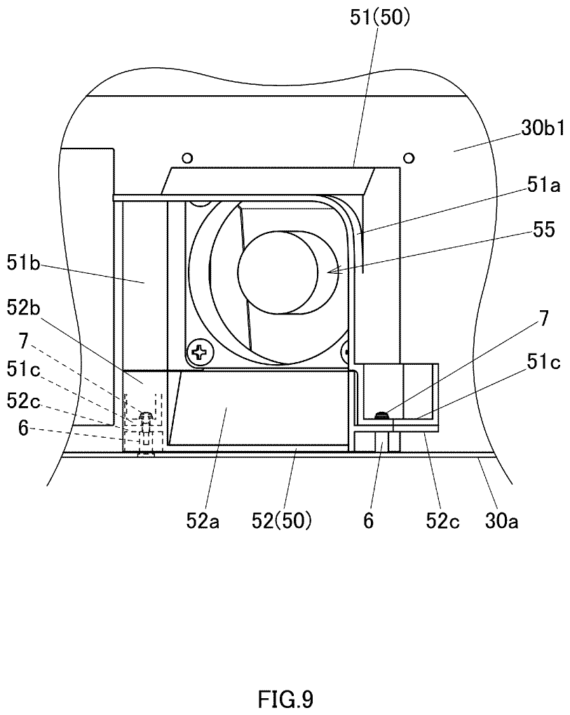

A fan 55 is provided in a position on the rear surface (an internal surface) of the front side plate 30b which corresponds to the front intake/exhaust port 41. The fan 55 is configured as an outlet axial flow fan and is set in such a manner as to send air from the inside to the outside of the projector case 10 via the front intake/exhaust port 41. As shown in FIGS. 8 and 9, an internal duct 50 is provided on an outer circumference of the fan 55. The internal duct 50 is provided as an integrated body by combining an upper internal duct 51 on an upper side and a lower internal duct on a lower side together. Here, the upper internal duct 51 and the lower internal duct 52 may be integrated into one part which makes solely up the internal duct 50.

The upper internal duct 51 includes a tubular element 51a of substantially a tubular shape which extends rearwards from the outer circumference of the fan 55 which excludes a lower portion of the fan 55. The tubular element 51a is provided close to an upper surface and a right surface of the projector 100 (ala, refer to FIG. 4). A long rectangular front plate element 51b, which is long in the up-down direction, is provided on a left side of the tubular element 51a with plate surfaces thereof oriented in a front-rear direction. The front plate element 51b is provided close to a front surface of the projector 100. A flat plate 52d of the lower internal duct 52 is disposed at the lower portion of the fan 55. The fan 55 is surrounded along the outer circumference thereof by the tubular element 51a and the flat plate 52d.

The lower internal duct 52 includes an inclined plate 52a which inclines in such a manner as to descend to the rear from the flat plate 52d on the lower side of the fan 55 towards an upper surface of the bottom plate 30a of the case main body 30. A projecting end of the inclined plate 52a comes into abutment with the upper surface of the bottom plate 30a. A front plate element 52b is provided on a left side of the inclined plate 52a in such a manner that a plate surface continues to a plate surface of the front plate component 51b of the upper internal duct 51. The upper internal duct 51 and the lower internal duct 52 include fixing plates 51c, 52c, respectively, which project from left and right side surfaces thereof into a flange shape. The fixing plates 51c, 52c are fastened together with machine screws 7 which are screwed into internal threads of fixing spacers 6 which are provided in such a manner as to be fixed to the bottom plate 30a of the case main body 30.

As shown in FIG. 2, an infrared ray transmission area 13 is provided in the rear side plate 30b4 in the side plates 30b in a position lying slightly rightwards of a center of the rear side plate 30b4 in the left-right direction. This infrared ray transmission area 13 is configured the same as the infrared ray transmission area 12 in the front side plate 30b1.

As shown in FIG. 7, a left rear intake/exhaust port 42 and a right rear intake/exhaust port 43, which both constitute an intake/exhaust port 40, are provided individually on left and right sides of the red infrared ray area 13 in the rear side plate 30b4. The left rear intake/exhaust port 42 and the right rear intake/exhaust port 43 are both provided into substantially a regular quadrangular shape. Multiple or four attachment target holes 42a, 43a are provided on outer circumferences of the left rear intake/exhaust port 42 and the right rear intake/exhaust port 43, respectively, as multiple or four attachment target holes 40a of the intake/exhaust port 40. The attachment target holes 42a, 43a are provided in the same way as the way in which the attachment target holes 41a of the front intake/exhaust port 41 are provided. That is, the four attachment target holes 42a, 43a are provided in positions lying the predetermine disposition dimension L from axial centers of the left rear intake/exhaust port 42 and the right rear intake/exhaust port 43, respectively, in such a manner that the attachment target holes 42a, 43a are positioned at vertexes of a regular quadrangle, and nuts are also provided similarly so as to provide internal threads for the four attachment target holes 42a, 43a.

As shown in FIG. 2, an eyebolt 14 is provided on the right side plate 30b3. In addition, a lock device 15 is provided on the right side plate 30b3, and this lock device 15 is configured to be brought into engagement with a locking hook 31c on the case lid 31 to lock the case lid 31.

As shown in FIG. 1, a connection cable 17 for transmitting data such as image data to the projector 100 and an AC power supply cable 18 are passed through the left side plate 30b2 towards the inside and the outside of the projector case 10. Both the cables (the connection cable 17, the AC power supply cable 18) are provided adjacent to each other in a rearward position on the left side plate 30b2. Cable clamps 17a, 18a are provided on both the cables (the connection cable 17, the AC power supply cable 18), respectively, at connecting portions of both the cables (the connection cable 17, the AC power supply cable 18) and the left side plate 30b2, whereby dust and rainwater which attempt to enter the inside of the projector case 10 from the locations in the left side plate 30b2 where both the cables are passed therethrough are reduced.

A left intake/exhaust port 44 is provided on a front side of both the cables (the connection cable 17, the AC power supply cable 18) in the left side plate 30b2 as an intake/exhaust port 40. The left intake/exhaust port 44 has substantially a regular quadrangular shape. The left intake/exhaust port 44 is provided in the same shape (dimensions) as those of the left rear intake/exhaust port 42 and the right rear intake/exhaust port 43. The left intake/exhaust port 44 has multiple or four attachment target holes 44a which are provided on an outer circumference thereof as multiple attachment target holes 40a of the intake/exhaust port 40. The attachment target holes 44a are provided in the same way as the way in which the attachment holes 41a (and the attachment target holes 42a, 43a) of the front intake/exhaust port 41 are provided. That is, the four attachment target holes 44a are provided in positions lying the predetermine disposition dimension L from an axial center of the left intake/exhaust port 44 in such a manner that the attachment target holes 44a are positioned at vertexes of a regular quadrangle, and nuts are also provided similarly so as to provide internal threads for the four attachment target holes 44a.

As shown in FIGS. 4 and 5, the projector 100 includes the ZF adjustment device 150 as described above and also includes a circuit board case 152 in which a circuit board for the ZF adjustment device 150 on an upper surface side of the projector 100. The case 20 has a pedestal 160, and the projector 100 is fixed to the projector case 10 via the pedestal 160. As shown in FIG. 5, the pedestal 160 includes two plate-shaped pedestal fixing plates 161 which are parallel to the bottom plate 30a of the case main body 300 and are elongated in the front-rear direction, vertical plates 162 which are provided in such a manner as to be erected individually from the two pedestal fixing plates 161, and a projector resting plate 163 which connects the two vertical plates 162 together and which is parallel to the bottom plate 30a.

The pedestal 160 is placed in position in such a manner that the pedestal fixing plates 161 are placed on upper surfaces of the fixing spacers 6 which are fixed to the bottom plate 30a and that machine screws 7 which are passed through screw holes in the individual pedestal fixing plates 161 are screwed into the internal threads of the individual fixing spacers 6 as shown in FIG. 8 (also, refer to FIG. 4). Here, the projector resting plate 163 of the pedestal 160 is positioned further upwards than the pedestal fixing plates 161, and the pedestal fixing plates 161 are placed on the corresponding fixing spacers 6. As a result, a space 165 is provided between an upper surface of the bottom plate 30a of the case main body 30 and a lower surface of the projector resting plate 163, and the pedestal 160 fixes the projector 100 with the space 165 defined between an internal surface of the case 20 and itself.

An AC adapter 120, which is configured to be connected to a power supply jack 101 of the projector 100, is disposed in the space 165. Here, multiple restriction plates 163a are provided on the projector resting plate 163 by bending portions of the projector resting plate 163 from cuts of substantially a U-shape made therein through 90 degrees downwards (also, refer to FIG. 5). The AC adapter 120 is held in place by the multiple restriction plates 163a. A photosensor 167, configured to receive an infrared ray from a remote controller (not shown), is provided at the front and rear of the projector resting plate 163 of the pedestal 160 (refer to FIGS. 2 and 4).

As shown in FIG. 4, the connection cable 17 is pulled into the inside of the projector case 10 from the left side (the left side plate 30b2) to be connected to a connection terminal on a left surface of the projector 100. The AC power supply cable 18 is similarly pulled into the inside of the projector case 10 and is then pulled further towards a right side of the inside of the projector case 10 (a right side of the projector 100) to be connected to a tee tube 18b. Although wiring is not shown, a power supply is connected to the AC adapter 120 and the ZF adjustment device 150 (a power supply circuit of the circuit board accommodated in the circuit board case 152) via the tee tube 18b. An electromagnetic shield 19 made up of a punched metal is provided on a right side of the tee tube 18b of the AC power supply cable 18 which is pulled into the inside of the projector case 10.

Two hinges 36 are provided on a left frame surface 30d of the case main body 30 with their rotation shafts oriented in the front-rear direction. The case lid 31 is connected with the case main body 30 via the two hinges 36. The case lid 31 includes a lid surface plate 31a of a long rectangular shape, which is elongated in the left-right direction and is configured to face the opening area 30c in the case main body 30 when the case lid 31 is put in a closed state, and a lid edge 31b which is bent through 90 degrees from an edge of the lid surface plate 31a towards the case main body 30. The two hooks 31c described above are provided on an external surface of a right lid edge 31b. In the hinge 36, one side is fixed to an internal surface of the lid edge 31b of the case lid 31, and the other side is fixed to the frame surface 30d of the case main body 30.

As shown in FIGS. 4 and 5, a cushion 31d (a dust-proof component) of substantially a long rectangular shape is provided along the edge on an internal surface of the lid surface plate 31a of the case lid 31. In addition, a cushion 31e (a dust-proof component) is provided on an internal side of the lid surface plate 31a which corresponds to the connector 32 (the upper end face 32d) of the case main body 30. As shown in FIGS. 6 and 8, the cushion 31d is brought into press contact with the frame-shaped surface 30e1 when the case lid 31 is put in the closed state. Similarly, the cushion 31e is brought into press contact with the upper end face 32d of the base plate 32b of the connector 32 which is bent forwards through 90 degrees when the case lid 31 is put in the closed state. Dust and rainwater which attempt to enter from the outer circumference of the glass plate 11a are reduced by the cushion 31e together with the other cushions (the cushions 32c2, 32c3) which are provided on the connector 32.

The duct cover 80 (the duct cover 80A) is provided for each of the intake/exhaust ports 40 (the front intake/exhaust port 41, the left rear intake/exhaust port 42, the right rear intake/exhaust port 43, the left intake/exhaust port 44) (refer to FIGS. 1 to 3, and 7). The duct covers 80A (a first duct cover) provided individually for the intake/exhaust ports 40 have the same structure. In FIG. 7, as shown in a circled diagram which shows the dust cover 80 as seen from a side C, the duct cover 80A has a connection opening 81 which connects with the intake/exhaust port 40. The connection opening 81 is given a size which encompasses the intake/exhaust port 40 (in other words, an opening having an area larger than an area of the intake/exhaust port 40).

Multiple attachment holes 82 are provided on an outer circumference of the connection opening 81. Specifically speaking, multiple or four attachment holes 82 are disposed in a top left corner, a top right corner, a bottom left corner, and a bottom right corner of a flange 81a which is provided into a rectangular frame shape on the outer circumference of the connection opening 81 in such a manner as to be positioned at vertexes of a regular quadrangle. The multiple attachment holes 82 are provided individually in positions lying the predetermined disposition dimension L from an axial center 81CL of the connection opening 81 (an axial center 81CL which is at right angles to an opening plane in which the connection opening 81 is opened).

The connection opening 81 communicates with an external opening 84 via a duct 83. The external opening 84 opens into substantially a rectangular shape at an external end portion of the duct 83. In the present embodiment, a filter 85 is provided at the external opening 84 for reducing dust which attempts to enter the duct 83 via the external opening 84. The external opening 84 is disposed in such a manner that an axial center 84CL of the external opening 84 (an axial center 84CL which is at right angles to an opening plane in which the external opening 84 is opened) is at right angles to the axial center 81CL of the connection opening 81.

The dust cover 80A is attached to the case main body 30 (the case 20) with the attachment holes 82 and the attachment target holes 40a aligned with each other. Specifically speaking, machine screws 8 (screw components) are passed through the attachment holes 82 and are then screwed into the nuts (the internal threads, not shown) provided on the attachment target holes 40a, whereby the duct cover 80A is attached to the case 20. That is, the machine screws 8 and the nuts constitute fixing components for fixing the duct cover 80 to the case 20.

A cushion 86 of a rectangular frame shape is provided between the flange 81a of the duct cover 80A and a surface of the case main body 30 in which the attachment target holes 40a are provided. In FIG. 7, the cushion 86 provided between the front intake/exhaust port 41 and the duct cover 80A is described as an example of such a cushion. The cushion 86 is held by the flange 81a and the surface (a front surface of the front side plate 30b1) in which the attachment target holes 41a (the attachment target holes 40a) are provided, whereby dust attempting to enter the case main body 30 (the projector case 10) from the circumference of the intake/exhaust port 40 is reduced.

As has been described above, in the intake/exhaust ports 40, the left rear intake/exhaust port 42, the right rear intake/exhaust port 43, and the left intake/exhaust port 44 are formed into the opening of substantially a regular quadrangular shape, and the front intake/exhaust port 41 is formed into the opening of substantially an octagonal shape. Then, the connection opening 81 of the duct cover 80A is formed into the opening of substantially a regular quadrangular shape and is sized so as to encompass the left rear intake/exhaust port 42, the right rear intake/exhaust port 43, and the left intake/exhaust port 44.

The multiple attachment holes 82 of the duct cover 80A are provided in the positions lying the predetermined disposition dimension L from the axial center 81CL of the connection opening 81. On the other hand, the attachment target holes 40a (the attachment target holes 41a, 42a, 43a, 44a) are provided in the positions lying the predetermined disposition dimension L from the axial center 40CL (the axial center 40CL which is at right angles to the opening plane in which the intake/exhaust port 40 is opened) of the intake/exhaust port 40 (the left rear intake/exhaust port 42, the right rear intake/exhaust port 43, and the left intake/exhaust port 44).

That is, the duct cover 80A is attached to the case 20 in such a manner that the attachment holes 82 are aligned with the attachment target holes 40a (the attachment target holes 41a, 42a, 43a, 44a), whereby the axial center 81CL of the connection opening 81 is disposed substantially concentric with the axial center 40CL of the intake/exhaust port 40 (the front intake/exhaust port 41, the left rear intake/exhaust port 42, the right rear intake/exhaust port 43, and the left intake/exhaust port 44).

As a result, not only the duct cover 80A can be attached to any intake/exhaust port 40, but also the duct cover 80A can be attached by being rotated 90 degrees around the axial center 40CL of the intake/exhaust port 40 (the axial center 81CL of the connection opening 81 which is configured to be concentric with the axial center 40CL) each time. In other words, the duct cover 80A can be attached to the case 20 in multiple orientations.

In the present embodiment, the duct cover 80A is attached to the case main body 30 in such a manner that the external opening 84, of which the axial center 84CL is at right angles to the axial center 81CL of the connection opening 81, is positioned so as to be oriented towards the bottom plate 30a of the case main body 30. Here, as shown in FIG. 3, an external surface of the bottom plate 30a is configured as a setting surface 30a1. Multiple (four) setting components 30f, each including an internal thread and provided into a cylindrical shape, are provided on the setting surface 30a1 (also, refer to FIG. 8). The projector case 10 is fixedly set in such a state that the projector case 10 is placed flat with the setting plane 30a1 oriented downwards.

In the projector case 10, the setting surface 30a1 and the case lid 31 which is provided on the surface opposite to the setting surface 30a1 are configured as a large surface, while the four side surfaces (the side plates 30b) are configured as a small surface. Then, the intake/exhaust ports 40 are provided only in the side surfaces (the side plates 30b). In other words, the setting surface 30a1 is provided on the surface which differs from the surfaces in which the intake/exhaust ports 40 are provided. As a result, the duct cover 80A can be made small in size, and hence, the projector case 10 can also be made small in size.

In addition, as shown in FIG. 4, in the projector 100, air is taken in from an intake port 121 (arrows IP1, IP2) provided in a rear panel, an intake port 122 (an arrow IP3) provided in a front side of a left panel, and an intake port 123 (an arrow IP4) provided in substantially a central portion of a front panel, and is exhausted (an arrow EP1) from an exhaust port 124 provided in a right portion of the front panel. The intake/exhaust ports 42, 43 are provided in such a manner as to correspond to the intake port 121 of the projector 100, and the intake/exhaust port 44 is provided in such a manner as to correspond to the position of the intake port 122 of the projector 100 (in the vicinity of the intake ports 121, 122 of the projector 100 in such a state that the projector 100 is accommodated in the projector case 10). In addition, the front intake/exhaust port 41 is provided in such a manner as to correspond to the position of the exhaust port 124 of the projector 100 (in the vicinity of the exhaust port 124 of the projector 100). As a result, in the projector case 10, outside air is taken in from the left rear intake/exhaust port 42 (an arrow IE2), the right rear intake/exhaust port 43 (an arrow IE3), and the left intake/exhaust port 44 (an arrow IE4) in the intake/exhaust ports 40 and is then exhausted to the outside from the front intake/exhaust port 41 (an arrow IE1) based on an intake/exhaust capability of the projector 100. Due to this configuration, air can be taken in and exhaust from the projector 100 with good efficiency even in such a state that the projector 100 is accommodated in the projector case 10.

In addition, as indicated by arrows in FIG. 8, although air (cooling air) taken in from the left rear intake/exhaust port 42 and the right rear intake/exhaust port 43 is taken into the inside of the projector 100, a part thereof flows over an upper side of the projector 100 and a lower side of the projector 100 (through the space 165).

Cooling air that flows over the upper side of the projector 100 cools the circuit board case 152 of the ZF adjustment device 150. The cooling air that flows over the upper side of the projector 100 to cool the circuit board case 152 is taken into an inside of the projector 100 from the intake port provided in substantially the central portion of the front panel or a front side of the projector 100 (an arrow IP4 in FIG. 4).

The cooling air that flows over the lower side of the projector 100 cools the AC adapter 120 disposed in the space 165. The air that flows over the lower side of the projector 100 to cool the AC adapter 120 is guided towards the fan 55 to be exhausted by the inclined plate 52a of the internal duct 50 (the lower internal duct 52) (the arrow IE1 in FIG. 4).

Here, the circumference of the fan 55 is surrounded by the internal duct 50 and is provided in such a manner as to correspond to the exhaust port in the right side of the front surface of the projector 100 so that air is caused to flow to the fan 55 by the internal duct 50, so that loss of the air due to a reverse flow between the fan 55 and the projector 100 or the like is reduced.

As in the case with the present embodiment, the intake/exhaust ports 40 of the projector case 10 are preferably provided in such a manner as to correspond to the intake ports and the exhaust port of the projector 100. Here, the fan 55 is preferably configured as a fan 55 having the same capability as that of an exhaust fan of the projector 100 so as to match an exhaust capability from the exhaust port of the projector 100 (the capability of the exhaust fan of the projector 100). Depending upon the intake and exhaust capabilities of the projector 100, an intake fan may be provided for the intake/exhaust port 40 (in the present embodiment, the left rear intake/exhaust port 42, the right rear intake/exhaust port 43, or the left intake/exhaust port 44).

The filter 85 for the duct cover 80 (the duct cover 80A) can be provided or omitted to match a required dust-proof performance. For example, as in the present embodiment, in the case that the projector case 10 needs a dust-proof performance equal to or greater than the dust-proof performance of the projector 100, the filter 85 is provided on the duct cover 80. Here, from the viewpoint of a dust-proof performance, the filter 85 may not be provided on the duct cover 80A of the front intake/exhaust port 41 which constitutes the exhaust port; however, in the case that the projector case 10 is set outside, dust attempting to enter the inside of the projector case 10 can be reduced further by providing the filter 85 also on the duct cover 80A of the front intake/exhaust port 41 which constitutes the exhaust port. In addition, a net such as a metal net may be provided on an external side of the filter 85 for preventing the entrance of an insect or dust. Providing a net like this can not only prevent the detachment of the filter but also reduce further water such as rainwater and dust which attempt to enter the inside of the projector case 10.

As described above, since the projector case 10 illustrated in FIGS. 1 to 9 is set flat horizontally, the duct cover 80A is disposed in such a manner that the external opening 84 of the duct cover 80A is oriented towards the ground or floor. In other words, the axial center 84CL of the external opening 84 is at right angles to the setting surface 30a1. (That is, the external opening 84 is disposed in such a manner as to face the setting surface 30a1.) Consequently, even in the case that the projector case 10 is set outside, a risk of rainwater and dust which fall from above directly striking the external opening 84 is reduced.

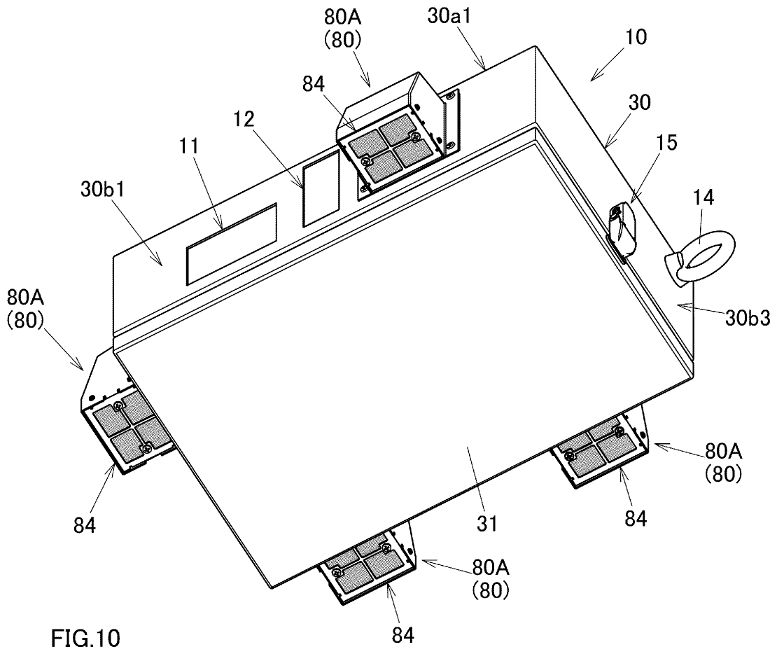

On the other hand, the projector case 10 can also be set with the setting surface 30a1 attached to a ceiling so as to be suspended from the ceiling as shown in FIG. 10, that is, with the case lid 31 oriented towards the ground or floor. For this, the duct covers 80A are attached to the intake/exhaust ports 40 by being rotated 180 degrees around the axial centers 81CL of the connection openings 81 from the state when the projector case 10 is set flat horizontally as shown in FIGS. 1 to 9, whereby the individual external openings 84 are disposed in such a manner as to be oriented towards the case lid 31. In this case, too, a risk of rainwater and dust which fall from above directly striking the external opening 84 is reduced.

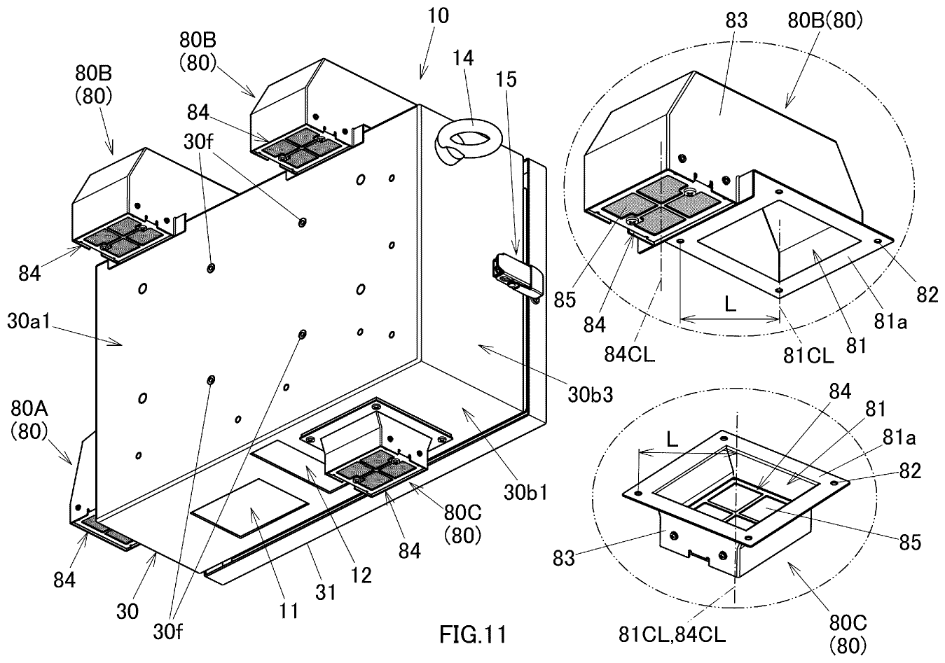

In addition, the projector case 10 can also be attached to a wall surface or the like which is perpendicular to a ground or floor surface as shown in FIG. 11 with the projected light emitting port 11 oriented towards the ground or floor surface (with the front side plate 30b1 oriented downwards) so as to emit projected light on to the floor surface (the ground surface). For this, in the intake/exhaust ports 40, a duct cover 80B (a second duct cover) is provided on each of the left rear intake/exhaust port 42, and the right rear intake/exhaust port 43, while a duct cover 80C (a third duct cover) is provided on the front intake/exhaust port 41.

As shown in an upper circled diagram in FIG. 11, the duct cover 80B is such that an axial center 81CL of a connection opening 81 (an axial center 81CL which is at right angles to an opening plane in which the connection opening 81 is opened) and an axial center 84CL of an external opening 84 (an axial center 84CL which is at right angles to an opening plane in which the external opening 84 is opened) are parallel to each other. In addition, attachment holes 82 of a flange 81a, a duct 83 which establishes a communication between the connection opening 81 and the external opening 84, and a filter 85 are provided as in the case with the duct cover 80A (the first duct cover). The multiple attachment holes 82 of the duct cover 80B are provided in positions lying the predetermined disposition dimension L from the axial center 81CL of the connection opening 81. In other words, the duct cover 80B can be attached to the case 20 in multiple orientations. The external opening 84 of the duct cover 80B is disposed so as to be oriented towards the same side of the case 20 as the setting surface 30a1.

In addition, as shown in a lower circled diagram in FIG. 11, the duct cover 80C is such that an axial center 81CL of a connection opening 81 (an axial center 81CL which is at right angles to an opening plane in which the connection opening 81 is opened) and an axial center 84CL of an external opening 84 (an axial center 84CL which is at right angles to an opening plane in which the external opening 84 is opened) are made concentric to each other (in other words, the axial center 81CL and the axial center 84CL coincide with each other). Also, in the duct cover 80C, attachment holes 82 of a flange 81a and a duct 83 which establishes a communication between the connection opening 81 and the external opening 84 are also provided in the duct cover 84C as in the case with the duct cover 80A. The multiple attachment holes 82 of the duct cover 80C are provided in positions lying the predetermined disposition dimension L from the axial center 81CL of the connection opening 81. In other words, the duct cover 80C can be attached to the case 20 in multiple orientations.

The duct cover 80A is provided on the left intake/exhaust port 44, and this duct cover 80A is attached to the left intake/exhaust port 44 by being rotated around the axial center 81CL of the connection opening 81 in such a manner that the external opening 84 is oriented to the floor surface (a projection plane), whereby the external opening 84 is disposed so as to be oriented in the same direction as the direction in which the projected light emitting port 11 is oriented.

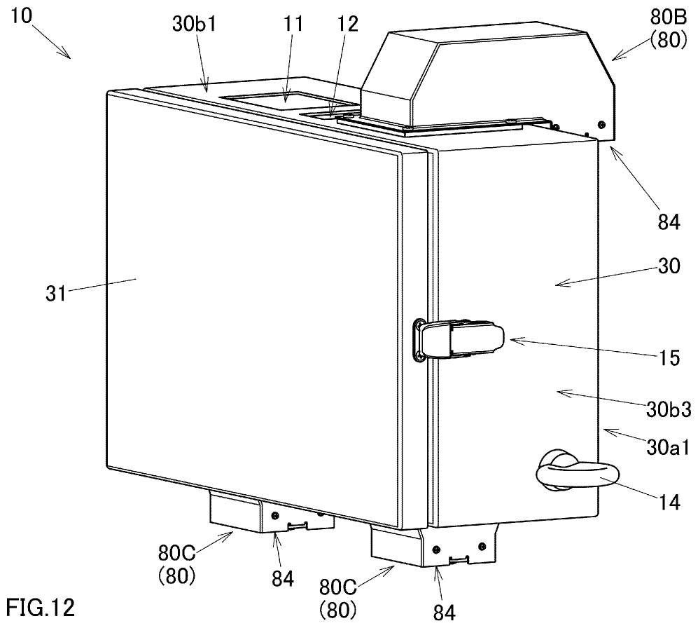

Further, as shown in FIG. 12, the projector case 10 can also be set with the setting surface 30a1 set on a wall surface or the like which is perpendicular to the ground surface and the front side plate 30b1 disposed on a side facing the ceiling so that light is projected on to the ceiling for projection. In this case, the duct covers 80C are provided individually on the left rear intake/exhaust port 42 and the right rear intake/exhaust port 43, while the duct cover 80B is provided on the front intake/exhaust port 41. Although not shown, the duct cover 80A is provided on the left intake/exhaust port 44. The duct cover 80A is disposed in such a manner that the external opening 84 is oriented to an opposite side to the side in which the projected light emitting port 11 is provided.

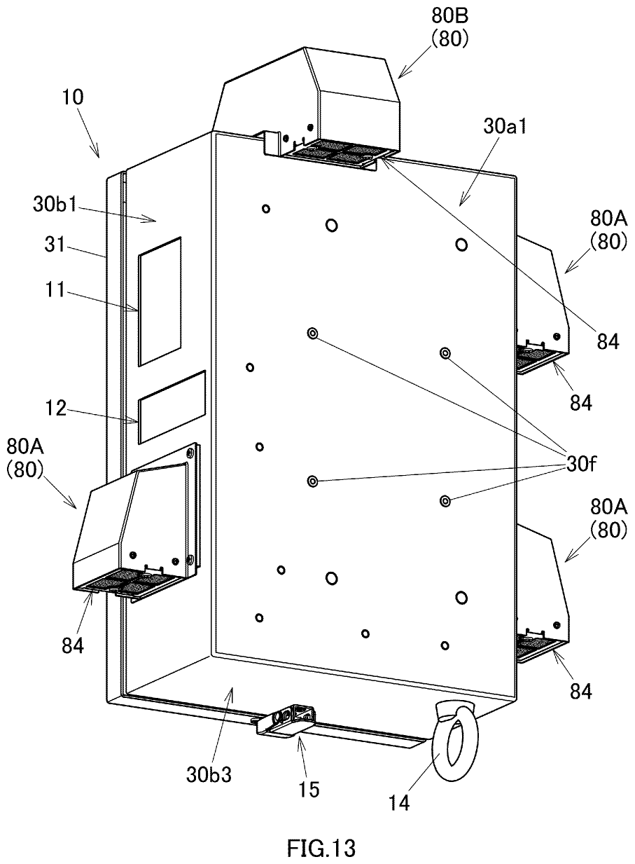

Furthermore, as shown in FIG. 13, the projector case 10 can also be set with the setting surface 30a1 attached to a wall surface or the like which is perpendicular to the ground surface and the right side plate 30b3 disposed so as to be oriented downwards so that a projected screen becomes vertical (so as to project a projected image which is longer in the up-down direction than in the left-right direction). In this case, the duct covers 80A are provided individually on the front intake/exhaust port 41, the left rear intake/exhaust port 42, and the right rear intake/exhaust port 43. In these duct covers 80A, the external opening 84 is disposed so as to be oriented downwards. In addition, the duct cover 80B is provided on the left intake/exhaust port 44. The duct cover 80B is disposed in such a manner that the external opening 84 lies on the same side as the setting surface 30a1 while being oriented downwards.

In this way, with the projector case 10, the duct covers 80 (the duct covers 80A, 80B, 80C) are selected appropriately for the intake/exhaust ports 40 or are attached to the case 20 by being rotated around the axial center 81CL of the connection opening 81 (the axial center 40CL), whereby the duct covers 80 can be disposed with the external openings 84 oriented towards the ground surface even though the projector case 10 is set in the various states.

The multiple attachment target holes 40a which are provided on the outer circumference of the intake/exhaust port 40 are not limited to the embodiment that has been described heretofore, and hence various aspects can be adopted, as long as the attachment target holes 40a are provided in positions lying the predetermined disposition dimension L from the axial center 40CL of the intake/exhaust port 40 (the axial center 81CL of the connection opening 81 of the duct cover 80 which is disposed concentrical with the intake/exhaust port 40 and which is connected to the intake/exhaust port 40).

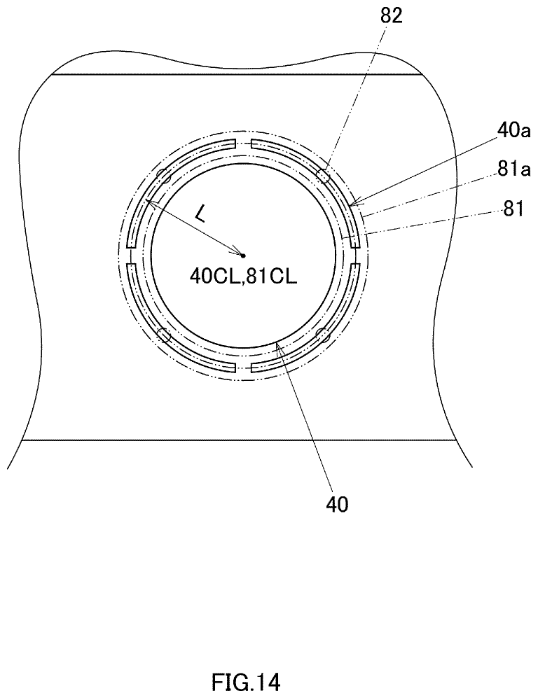

For example, as in the case with a modified example shown in FIG. 14, multiple attachment target holes 40a, which are elongated holes of substantially an arc shape, are provided on an outer circumference of a circular intake/exhaust port 40, and the multiple attachment target holes 40a can also be disposed in positions lying the predetermined disposition dimension L from an axial center 40CL of the intake/exhaust port 40. In this modified example, the attachment target holes 40a are the elongated holes of the arc shape. In other words, the multiple attachment target holes 40a are disposed on the same circumference which is centered at the axial center 40CL. A circular connection opening 81 sized so as to encompass the intake/exhaust port 40 is provided in a duct cover 80. Multiple attachment holes 82, which are configured as circular holes, are provided in a flange 81a on an outer circumference of the connection opening 81. The multiple attachment holes 82 are provided in positions lying the predetermined disposition dimension L from an axial center 81CL of the connection opening 81.

The duct cover 80 can be fixed to the intake/exhaust port 40 by causing bolts to pass through the attachment target holes 40a and the attachment holes 82 and screwing nuts on the bolts from an opposite side of the bolts. For this, the axial center 40CL and the axial center 81CL are disposed concentrically. In the configuration shown in FIG. 14, the duct cover 80 can be disposed so as to rotate around the axial center 40CL (the axial center 81CL) by an extent corresponding to a length of the arc shape of the attachment target hole 40a.

A problem of the projector case of the related art described above will be described. With the projector case of the related art, the projection direction can be changed within a predetermined range by adjusting the connection of the projector with the attachment stay or the panning direction rotation element. However, since the attachment directions of the panning direction rotation element and an entrance suppression cover to a main body of the projector case are fixed, the change in the projection direction by changing the setting place of the projector case for a floor projection, a horizontal projection, and the like is limited.

In contrast with the projector case of the related art, according to the embodiment of the present disclosure, the projector case 10 constitutes the projector case 10 for accommodating the projector 100, including the case 20 having formed therein the intake/exhaust ports 40 and the multiple attachment target holes 40a which are provided on the outer circumferences of the intake/exhaust ports 40, and the duct covers 80 each configured to be attached to the case 20 in the multiple orientations and having formed therein the connection openings 81 connecting to the intake/exhaust ports 40, the external openings 84 communicating with the connection openings 81, and the multiple attachment holes 82 which are provided on the outer circumferences of the connection openings 81.

As a result, the duct cover 80 can be attached to the case 20 while being rotated around the axial center 84CL of the external opening 84 so as to change the orientation of the external opening 84 in accordance with the setting state of the projector case 10, whereby the projector case 10 can also be set outside in the various states including the state in which the projector case 10 is placed flat horizontally or suspended from the ceiling, the state in which the projector case 10 is disposed for the ceiling projection or the floor projection, and the like. As a result, the projector case can be provided which mitigates the restriction on the change in the projection direction by mitigating the restriction on the setting of the projector case.

In addition, the attachment target holes 40a and the attachment holes 82 are both provided in such a manner as to be positioned at vertexes of a regular quadrangle. As a result, the duct cover 80 can be attached to the case 20 by being rotated 90 degrees around the axial center 81CL (the axial center 40CL) each time. In the present embodiment, while the attachment target holes 40a and the attachment holes 82 are both provided in such a manner as to be positioned at vertexes of a regular quadrangle, in addition to this, the attachment target holes 40a and the attachment holes 82 can both be provided in such a manner as to be positioned at vertexes of a regular polygon such as a regular triangle, a regular hexagon, a regular octagon, and the like.

In addition, the attachment target hole 40a is also formed into the elongated hole of the arc shape. As a result, the duct cover 80 can be attached to the case 20 by being rotated around the axial center 81CL of the duct cover 80 (the axial center 40CL) within the predetermined range which is specified by the length of the attachment target hole 40a which is provided as the elongated hole.

Additionally, the duct cover 80 is any one of the duct cover 80A (the first duct cover) which is formed in such a manner that the axial center 84CL of the external opening 84 is at right angles to the axial center 81CL of the connection opening 81, the duct cover 80B (the second duct cover) which is formed in such a manner that the axial center 84CL of the external opening 84 is parallel to the axial center 81CL of the connection opening 81, and the duct cover 80C (the third duct cover) which is formed in such a manner that the axial center 84CL of the external opening 84 is positioned concentric with the axial center 81CL of the connection opening 81. The external opening 84 can be disposed in the direction, which is at right angles to, parallel to, or the same direction as the exhaust direction of the intake/exhaust port 40.

The case 20 is formed into the rectangular parallelepiped shape. The setting surface 30a1 is provided on the surface which differs from the side surfaces in which the intake/exhaust ports 40 are formed. As a result, even though the setting surface 30a1 is fixed and the setting components 30f are provided on the setting surface 30a1, the projector case 10 can be set in the various forms.

The case lid 31 is provided on the surface of the case 20 which is opposite to the setting surface 30a1. As a result, the opening area 30c, which is opened largely, can be provided, whereby the projector case 10 can be provided which can accommodate the projector 100 and the AC adapter 120 and facilitate the wiring operations of the cables.

The projector case 10 includes the fixing components which are passed through the attachment target holes 40a and the attachment holes 82 so as to fix the duct cover 80 to the case 20. As a result, the duct cover 80 can be fixed to the case 20 in an ensured fashion by use of the fixing components made up of the simple screw structure or the like.

The case 20 has the projected light emitting port 11 and the connector 32 for connecting the projected light emitting port 11 with the projection port 110 of the projector 100, and the cushions 32c1, 32c2, which function as the dust-proof components, are provided between the projected light emitting port 11 and the projection port 110, and the connector 32. As a result, dust and rainwater which attempt to enter the projection port 110 of the projector 100 are reduced, whereby a good projection can be performed.

The case 20 has the pedestal 160 on which the projector 100 is disposed, and the pedestal 160 fixes the projector 100 with the space 165 defined between the internal surface of the case 20 and itself. As a result, the accessories to the projector 100 such as the AC adapter 120 and the like can be accommodated below the projector 100 in the case 20.

The projector case 10 includes further the fan 55 provided in the front intake/exhaust port 41 and the internal duct 50 which is provided on the outer circumference of the fan 55. The internal duct 50 includes the inclined plate 52a which inclines in such a manner as to descend from the lower side of the fan 55 towards the upper surface of the bottom plate 30a of the case 20. As a result, the cooling air which flows in towards the upper surface of the bottom plate 30a below the pedestal 160 can be guided to the fan 55 in an ensured fashion.

The intake/exhaust port 40 is provided in such a manner as to correspond to the positions of the intake ports 121, 122 or the position of the exhaust port 124 of the projector 100. As a result, the cooling air which flows in from the intake/exhaust ports 40 flows directly to the intake ports 121, 122 of the projector 100, and the exhaust air from the exhaust port 124 of the projector 100 is exhausted directly from the intake/exhaust port 40, whereby the flow path loss can be reduced.

While the embodiments of the present invention have been described heretofore, the embodiments are presented as the examples, and hence, there is no intention to limit the scope of the present invention by the embodiments. The novel embodiments can be carried out in other various forms, and various omissions, replacements and modifications can be made thereto without departing from the spirit and scope of the present invention. Those resulting embodiments and modified examples thereof are included in the scope and gist of the present invention and are also included in the scope of inventions claimed for patent under claims below and their equivalents.

What is claimed is:

1. A projector case capable of accommodating a projector, comprising:
a case having formed therein an intake/exhaust port and multiple attachment target holes, the multiple attachment target holes being provided on an outer circumference of the intake/exhaust port; and
a duct cover configured to be attached to the case in multiple orientations and having formed therein a connection opening connecting to the intake/exhaust port, an external opening communicating with the connection opening, and multiple attachment holes, the multiple attachment holes being provided on an outer circumference of the connection opening.

2. The projector case according to claim 1,
wherein the attachment target holes and the attachment holes are both provided in such a manner as to be positioned at vertexes of a regular polygon.

3. The projector case according to claim 1,
wherein each of the multiple attachment target holes is an elongated hole of an arc shape.

4. The projector case according to claim 1,
wherein the duct cover is configured in such a manner that an axial center of the external opening is at right angles to an axial center of the connection opening.

5. The projector case according to claim 1,
wherein the duct cover is configured in such a manner that an axial center of the external opening is positioned parallel to an axial center of the connection opening.

6. The projector case according to claim 1,
wherein the duct cover is configured in such a manner that an axial center of the external opening is positioned concentric with an axial center of the connection opening.

7. The projector case according to claim 1, further comprising:
a fixing component configured to be passed through the attachment target hole and the attachment hole to fix the duct cover to the case.

8. The projector case according to claim 1,
wherein the case comprises a projected light emitting port and a connector configured to connect the projected light emitting port with a projection port of the projector, and
wherein a dust-proof component is provided between the projected light emitting port and the projection port, and the connector.

9. The projector case according to claim 1,
wherein the case comprises a pedestal configured to fix the projector with a space defined between an internal surface of the case and the pedestal.

10. The projector case according to claim 1, further comprising:
a fan provided in the intake/exhaust port; and
an internal duct provided on an outer circumference of the fan,
wherein the internal duct comprises an inclined plate configured to incline in such a manner as to descend from a lower side of the fan towards an upper surface of a bottom plate of the case.

11. The projector case according to claim 1,
wherein the intake/exhaust port is provided in such a manner as to correspond to a position of an intake port or an exhaust port of the projector.

12. The projector case according to claim 2,
wherein four attachment target holes and four attachment holes are provided, each positioned at vertexes of a regular quadrangle.

13. The projector case according to claim 1,
wherein a filter is provided at the external opening so as to reduce dust attempting to enter the external opening.
